(19) United States
(12) Patent Application Publication
(10) Pub. No.: US 2020/0029378 A1
(43) Pub. Date: Jan. 23, 2020

(54) USER EQUIPMENT, BASE STATION, AND RELATED METHODS

(71) Applicants: SHARP KABUSHIKI KAISHA, Sakai City, Osaka (JP); FG Innovation Company Limited, Tuen Mun (HK)

(72) Inventors: FANGYING XIAO, Shanghai (CN); RENMAO LIU, Shanghai (CN); SHOHEI YAMADA, Sakai City (JP)

(21) Appl. No.: 16/335,656

(22) PCT Filed: Aug. 15, 2017
(86) PCT No.: PCT/CN2017/097495

§ 371 Date: Mar. 21, 2019

(30) Foreign Application Priority Data
Sep. 22, 2016 (CN) 201610842285.2

(51) Int. Cl. H04W 76/15; H04W 8/24

(52) U.S. Cl. CPC H04W 76/15; H04W 8/24

(57) ABSTRACT

The present disclosure provides user equipment (UE), a base station, and related methods. A method executed by UE, the method comprises: sending to a master base station UE capability information related to bearer types supported by the UE, wherein the bearer types comprise New Radio (NR), Long Term Evolution (LTE), and/or enhanced Long Term Evolution (eLTE); and receiving, from the master base station, configurations of the bearer types.

### TECHNICAL FIELD

The present disclosure relates to the field of wireless communications technologies. More specifically, the present disclosure relates to user equipment, a base station, and related methods.

### BACKGROUND

A new research project on 5G technical standards (see non-patent literature: RP-160671: New SID Proposal: Study on New Radio Access Technology) was proposed by NTT DOCOMO in the 3rd Generation Partnership Project (3GPP) RAN#71 plenary session held in March 2016, and was approved. The purpose of the research project is to develop a New Radio (NR) access technology to meet all application scenarios, needs, and deployment environments of 5G. NR has three main application scenarios: Enhanced Mobile Broadband Communications (Enhanced Mobile Broadband: eMBB), massive Machine Type Communication (mMTC), and Ultra Reliable and Low Latency Communications (URLLC). According to the planning of the research project, the standardization of NR is conducted in two stages: the first-stage standardization will be completed by the middle of 2018; the second-stage standardization will be completed by the end of 2019. The first-stage standard specifications need to be forward-compatible with the second-stage standard specifications, while the second-stage standard specifications need to be established on the basis of the first-stage standard specifications and to meet all requirements of 5G NR technical standards.

The NR dual-connection deployment scenarios attained in the 3GPP RAN2#95 session held in August 2016 include the deployment scenarios shown in FIGS. 1-4.

In FIG. 1, an NR base station (NR Node B, gNB for short) is shown. The gNB is a logical node that serves as a master base station (referred to as an MgNB) responsible for radio transmission and reception to and from user equipment (UE) in one or more cells. That is, a control plane connection is established between the MgNB and a next-generation core network (referred to as NextGen Core). A data stream is transmitted through the NR base station and an enhanced Long Term Evolution (eLTE) base station (referred to as an eLTE eNB) over the next-generation core network. Specifically, four user plane data transmission modes exist: mode a1: user plane data is transmitted over the next-generation core network and using resources provided by the gNB (a corresponding data bearer is referred to as an NR master cell group (MCG) bearer); mode a2: user plane data is transmitted over the next-generation core network and using resources provided by the eLTE eNB (a corresponding data bearer is referred to as an NR secondary cell group (SCG) bearer); mode a3: user plane data is transmitted between the gNB and the next-generation core network, where one part of the data is transmitted using radio resources of the gNB, and the other part of the data is sent to and from the eLTE eNB through an interface between the gNB and the eLTE eNB and is transmitted using radio resources of the eLTE, eNB (a corresponding data bearer is referred to as an NR MCG split bearer); mode a4: user plane data is transmitted between the eLTE eNB and the next-generation core network, where one part of the data is transmitted directly using radio resources of the gNB, and the other part of the data is sent to and from the eLTE eNB through an interface between the gNB and the eLTE eNB and is transmitted using radio resources of the eLTE eNB (a corresponding data bearer is referred to as an NR SCG split bearer). In modes a3 and a4, user plane data is transmitted using resources provided by both the gNB and the eLTE eNB over the next-generation core network.

In FIG. 2, both a master base station MgNB and a secondary base station SgNB are gNBs. That is, a control plane connection is established between the MgNB and a next-generation core network, and a data stream is transmitted through the MgNB and the SgNB over the next-generation core network. Specifically, four user plane data transmission modes exist: mode b1: user plane data is transmitted over the next-generation core network and using resources provided by the MgNB (a corresponding data bearer is referred to as an NR MCG bearer); mode b2: user plane data is transmitted over the next-generation core network and using resources provided by the secondary base station SgNB (a corresponding data bearer is referred to as an NR SCG bearer); mode b3: user plane data is transmitted between the MgNB and the next-generation core network, where one part of the data is transmitted using radio resources of the master base station MgNB, and the other part of the data is sent to and from the SgNB through an interface between the master base station MgNB and the secondary base station SgNB and is transmitted using radio resources of the SgNB (a corresponding data bearer is referred to as an NR MCG split bearer); and mode b4: user plane data is transmitted between the SgNB and the next-generation core network, where one part of the data is transmitted directly using radio resources of the SgNB, and the other part of the data is sent to and from the MgNB through an interface between the SgNB and the MgNB and is transmitted using radio resources of the MgNB (a corresponding data bearer is referred to as an NR SCG split bearer). In modes b3 and b4, user plane data is transmitted using resources provided by both the MgNB and the SgNB over the next-generation core network.

In FIG. 3, a Long Term Evolution base station (LTE eNB) serves as a master base station (referred to as an LTE MeNB). That is, a control plane connection is established between the LTE eNB and a core network (referred to as an EPC), and a data stream is transmitted through a gNB and the LTE eNB over the EPC. Specifically, four user plane data transmission modes exist: mode c1: user plane data is transmitted over the EPC and using resources provided by the LTE eNB (a corresponding data bearer is referred to as an LTE MCG bearer); mode c2; user plane data is transmitted over the EPC and using resources provided by the gNB (a corresponding data bearer is referred to as an LTE SCG bearer); mode c3: user plane data is transmitted between the LTE eNB and the EPC, where one part of the data is transmitted using radio resources of the LTE eNB, and the other part of the data is sent to and from the gNB through an interface between the gNB and the LTE eNB and is transmitted using radio resources of the gNB (a corresponding data bearer is referred to as an LTE MCG split bearer); and mode c4: user plane data is transmitted between the gNB and the EPC, where one part of the data is transmitted directly using radio resources of the gNB, and the other part of the data is sent to and from the LTE eNB through an interface between the gNB and the LTE eNB and is transmitted using radio resources of the LTE eNB (a corresponding data bearer is referred to as an LTE SCG split bearer). In modes c3 and c4, user plane data is transmitted using resources provided by both the gNB and the LTE eNB over the EPC.

In FIG. 4, an eLTE eNB serves as a master base station (referred to as an eLTE MeNB), and a data stream is transmitted through a gNB and the eLTE eNB over a next-generation core network. Specifically, four user plane data transmission modes exist: mode d1: user plane data is transmitted over the next-generation core network and using resources provided by the eLTE eNB (a corresponding data bearer is referred to as an eLTE MCG bearer); mode d2: user plane data is transmitted over the next-generation core network and using resources provided by the gNB (a corresponding data bearer is referred to as an eLTE SCG bearer); mode d3: user plane data is transmitted between the eLTE eNB and the next-generation core network, where one part of the data is transmitted using radio resources of the eLTE eNB, and the other part of the data is sent to and from the gNB through an interface between the gNB and the eLTE eNB and is transmitted using radio resources of the gNB (a corresponding data bearer is referred to as an eLTE MCG split bearer); and mode d4: user plane data is transmitted between the gNB and the next-generation core network, where one part of the data is transmitted directly using radio resources of the gNB, and the other part of the data is sent to and from the eLTE eNB through an interface between the gNB and the eLTE eNB and is transmitted using radio resources of the eLTE eNB (a corresponding data bearer is referred to as an eLTE SCG split bearer). In modes d3 and d4, user plane data is transmitted using resources provided by both the gNB and the eLTE eNB over the next-generation core network.

Based on the NR deployment scenarios, different types of user equipment may support different types of data bearers (DRBs). When a different type of UE accesses a network, a base station (including an LTE eNB, an eLTE eNB, and a gNB) needs to configure appropriate radio resources for the UE according to a DRB type supported by the UE. If the base station configures for the UE radio resources not supported by the user equipment, a configuration error is caused. Therefore, the UE needs to report the DRB type it supports.

### SUMMARY OF INVENTION

According to a first aspect of the present disclosure, a method executed by user equipment (UE) is provided, the method comprises: sending to a master base station UE capability information related to bearer types supported by the UE, wherein the bearer types comprise New Radio (NR), Long Term Evolution (LTE), and/or enhanced Long Term Evolution (eLTE); and receiving, from the master base station, configurations of the bearer types. In one embodiment, the UE capability information indicates whether the UE supports one or more of the following:

a master cell group (MCG) split bearer not comprising Packet Data Convergence Protocol (PDCP) uplink data transmission;

a secondary cell group (SCG) bearer;

an SCG split bearer not comprising uplink PDCP data transmission;

an MCG split bearer of PDCP uplink data transmission; and.

an SCG split bearer of PDCP uplink data transmission,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station, an LTE base station, or an eLTE base station; the secondary base station is an NR base station, an LTE base station, or an eLTE base station; and the core network is an evolved packet core (EPC) or a next-generation core network.

In one embodiment, the UE capability information indicates whether the UE supports one or more of the following:

an MCG split bearer not comprising PDCP uplink data transmission and using an NR base station as the master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an NR base station as the master base station and an LTE base station as a secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station as the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station; the secondary base station is an NR base station, an LTE base station, or an eLTE base station; and the core network is a next-generation core network.

In one embodiment, the UE capability information indicates whether the JE supports one or more of the following:

an MCG split bearer not comprising PDCP uplink data transmission and using an LTE base station as the master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission using an LTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the LTE capability information indicates whether the UE supports one or more of the following:

an MCG split bearer not comprising PDCP uplink data transmission and using an LTE base station as the master base station and an LTE base station as a secondary base station;

an MCG split bearer not comprising PDCP uplink data transmission and using an LTE base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LTE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an LTE base station; the secondary base station is an NR base station, an LTE base station, or an eLTE base station; and the core network is an EPC.

In one embodiment, the UE capability information indicates whether the UE supports one or more of the following:

an MCG split bearer not comprising PDCP uplink data transmission and using an eLTE base station as the master base station;

an SCG bearer using an eLTE, base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an eLTE base station as the master base station and an LTE base station as a secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an LTE base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an LTE base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an LTE base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an eLTE base station; the secondary base station is an NR base station, an LTE base station, or an eLTE base station; and the core network is a next-generation core network.

According to a second aspect of the present disclosure, user equipment (UE) is provided, comprising: a sending unit, a sending unit, configured to send to a master base station UE capability information related to bearer types supported by the UE, wherein the bearer types comprise New Radio (NR), Long Term Evolution (LTE), and/or enhanced Long Term Evolution (eLTE); and a receiving unit, configured to receive, from the master base station, configurations of the bearer types.

In one embodiment, the UE capability information indicates whether the UE supports one or more of the following:

a master cell group (MCG) split bearer not comprising Packet Data Convergence Protocol (PDCP) uplink data transmission;

a secondary cell group (SCG) bearer;

an SCG split bearer not comprising uplink PDCP data transmission;

an MCG split bearer of PDCP uplink data transmission; and

an SCG split bearer of PDCP uplink data transmission,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station, an LTE base station, or an eLTE base station; the secondary base station is an NR base station, an LTE base station, or an eLTE base station; and the core network is an evolved packet core (EPC) or a next-generation core network.

In one embodiment, the UE capability information indicates whether the UE supports one or more of the following:

an MCG split bearer not comprising PDCP uplink data transmission and using an NR base station as the master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an NR base station as the master base station and an LTE base station as a secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station as the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station; the secondary base station is an NR base station, an LTE base station, or an eLTE base station; and the core network is a next-generation core network.

In one embodiment, the UE capability information indicates whether the UE supports one or more of the following:

an MCG split bearer not comprising PDCP uplink data transmission and using an LTE base station as the master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission using an LTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an LTE base station as the master base station and an LTE base station as a secondary base station;

an MCG split bearer not comprising PDCP uplink data transmission and using an LTE base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LTE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE, base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an LTE base station; the secondary base station is an NR base station, an LTE base station, or an eLTE base station; and the core network is an EPC.

In one embodiment, the UE capability information indicates whether the UE supports one or more of the following:

an MCG split bearer not comprising PDCP uplink data transmission and using an eLTE base station as the master base station;

an SCG bearer using an eLTE base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the JE supports one or more of the following:

an MCG split bearer not comprising PDCP uplink data transmission and using an eLTE base station as the master base station and an LTE base station as a secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an LTE base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an LTE base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an eLTE base station; the secondary base station is an NR base station, an LTE base station, or an eLTE base station; and the core network is a next-generation core network.

According to a third aspect of the present disclosure, a method executed by a base station is provided, the base station being used as a master base station, the method comprising:

receiving, from UE, UE capability information related to bearer types supported by the UE, wherein the bearer types comprise New Radio (NR), Long Term Evolution (LIE), and/or enhanced Long Term Evolution (eLTE); and

sending to the UE configurations of the bearer types according to the received UE capability information.

In one embodiment, the UE capability information indicates whether the UE supports one or more of the following:

a master cell group (MCG) split bearer not comprising Packet Data Convergence Protocol (PDCP) uplink data transmission;

a secondary cell group (SCG) bearer;

an SCG split bearer not comprising uplink PDCP data transmission;

an MCG split bearer of PDCP uplink data transmission; and

an SCG split bearer of PDCP uplink data transmission,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station, an LTE base station, or an eLTE base station; the secondary base station is an NR base station, an LTE base station, or an eLTE base station; and the core network is an evolved packet core (EPC) or a next-generation core network.

In one embodiment, the LTE capability information indicates whether the UE supports one or more of the following:

an MCG split bearer not comprising PDCP uplink data transmission and using an NR base station as the master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an NR base station as the master base station and an LTE base station as a secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station as the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station; the secondary base station is an NR base station, an LTE base station, or an eLET base station; and the core network is a next-generation core network.

In one embodiment, the UE capability information indicates whether the UE supports one or more of the following:

an MCG split bearer not comprising PDCP uplink data transmission and using an LTE base station as the master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission using an LTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an LTE base station as the master base station and an LTE base station as a secondary base station;

an MCG split bearer not comprising PDCP uplink data transmission and using an LTE base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LTE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an LTE base station; the secondary base station is an NR base station, an LTE base station, or an eLTE base station; and the core network is an EPC.

In one embodiment, the LTE capability information indicates whether the UE supports one or more of the following:

an MCG split bearer not comprising PDCP uplink data transmission and using an eLTE base station as the master base station;

an SCG bearer using an eLTE base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the LTE capability information indicates whether the UE supports one or more of the following:

an MCG split bearer not comprising PDCP uplink data transmission and using an eLTE base station as the master base station and an LTE base station as a secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an LTE base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an um base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an LTE base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an eLTE base station; the secondary base station is an NR base station, an LTE base station, or an eLTE base station; and the core network is a next-generation core network.

According to a fourth aspect of the present disclosure, a base station is provided, the base station being used as a master base station, the base station comprising:

a receiving unit, configured to receive, from UE, UE capability information related to bearer types supported by the UE, wherein the bearer types comprise New Radio (NR), Long Term Evolution (LTE), and/or enhanced Long Term Evolution (eLTE); and

a sending unit, configured to send to the UE configurations of the bearer types according to the received UE capability information.

In one embodiment, the UE capability information indicates whether the UE supports one or more of the following:

a master cell group (MCG) split bearer not comprising Packet Data Convergence Protocol (PDCP) uplink data transmission;

a secondary cell group (SCG) bearer;

an SCG split bearer not comprising uplink PDCP data transmission;

an MCG split bearer of PDCP uplink data transmission; and

an SCG split bearer of PDCP uplink data transmission,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station, an LTE base station, or an eLTE base station; the secondary base station is an NR base station, an LTE base station, or an eLTE base station; and the core network is an evolved packet core (EPC) or a next-generation core network.

In one embodiment, the UE capability information indicates whether the UE supports one or more of the following:

an MCG split bearer not comprising PDCP uplink data transmission and using an NR base station as the master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an NR base station as the master base station and an LTE base station as a secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station as the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station; the secondary base station is an NR base station, an LTE base station, or an eLTE base station; and the core network is a next-generation core network.

In one embodiment, the UE capability information indicates whether the UE supports one or more of the following:

an MCG split bearer not comprising PDCP uplink data transmission and using an LTE base station as the master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission using an LTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an LTE base station as the master base station and an LTE base station as a secondary base station;

an MCG split bearer not comprising PDCP uplink data transmission and using an LTE base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LTE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an LTE base station; the secondary base station is an NR base station, an LTE base station, or an eLTE base station; and the core network is an EPC.

In one embodiment, the UE capability information indicates whether the UE supports one or more of the following:

an MCG split bearer not comprising PDCP uplink data transmission and using an eLTE base station as the master base station;

an SCG bearer using an eLTE base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station,

wherein a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an eLTE base station as the master base station and an LTE base station as a secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an LTE base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an LTE base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an LTE base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station,

wherein a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an eLTE base station; the secondary base station is an NR base station, an LTE base station, or an eLTE base station; and the core network is a next-generation core network.

### BRIEF DESCRIPTION OF DRAWINGS

The above and other features of the present disclosure will become more apparent with the following detailed description in conjunction with the accompanying drawings.

FIG. 1 is a schematic diagram of an NR-eLTE dual-connection deployment scenario.

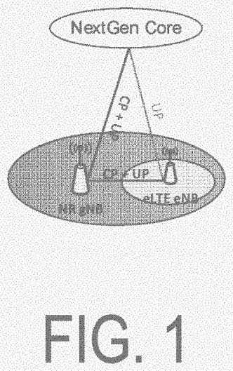

FIG. 2 is a schematic diagram of an NR-NR dual-connection deployment scenario.

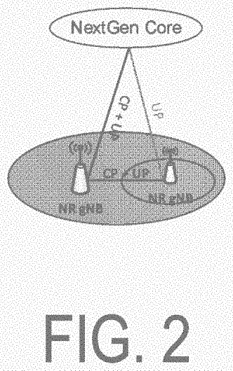

FIG. 3 is a schematic diagram of an LTE-NR dual-connection deployment scenario.

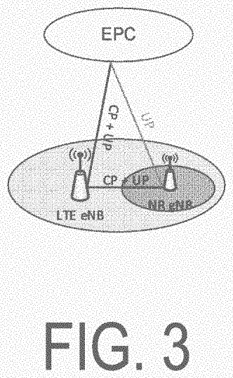

FIG. 4 is a schematic diagram of an eLTE-NR dual-connection deployment scenario.

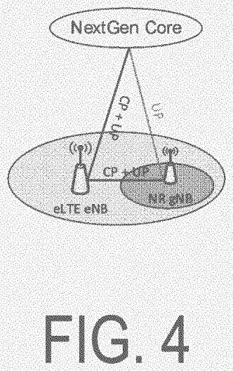

FIG. 5 is a flowchart of a method used in user equipment according to an embodiment of the present disclosure.

FIG. 6 is a block diagram of user equipment according to an embodiment of the present disclosure.

FIG. 7 is a flowchart of a method used in a base station according to an embodiment of the present disclosure.

FIG. 8 is a block diagram o base station according to an embodiment of the present disclosure.

### DETAILED DESCRIPTION OF EMBODIMENTS

The following describes the present disclosure in detail with reference to the accompanying drawings and specific embodiments. It should be noted that the present disclosure should not be limited to the specific embodiments described below. In addition, for simplicity, detailed description of well-known technologies not directly related to the present disclosure is omitted to avoid any confusion in understanding the present disclosure.

Some terms involved in the present invention are described below. If not specifically indicated, the terms involved in the present invention use the definitions herein. The present invention uses dual-connection as an example, but the method described in the present invention is not limited thereto; and those skilled in the art can easily expand the dual-connection scenarios to multi-connection scenarios.

In the present invention, a base station that connects a control plane to an EPC or a next-generation core network in a dual-connection mode is referred to as a master base station (MeNB), which may include one or more of an NR MgNB, an LTE MeNB, and an eLTE MeNB. A base station that does not connect a control plane to an EPC or a next-generation core network (that is, being not a master base station) but provides transmission resources for user plane data transmission is referred to as a secondary base station (SeNB), which may include one or more of an NR SgNB, an LTE SeNB, and an eLTE SeNB.

An X-Y MCG bearer involved in the present invention means that the master base station is X, the secondary base station is Y, and a radio protocol layer (radio protocols) of the bearer is located in X; and resources provided by X are used. X may be an NR MgNB, an LTE MeNB, or an eLTE MeNB; Y may be an NR SgNB, an LTE SeNB, or an eLTE SeNB.

An X-Y SCG bearer means that the MeNB is X, the SeNB is Y, and a radio protocol layer (radio protocols) of the bearer is located in Y; and resources provided by Y are used. X may be an NR MgNB, an LTE or an eLTE MeNB; Y may be an NR SgNB, an LTE SeNB, or an eLTE SeNB.

An X-Y MCG split bearer means that the master base station is X, the secondary base station is Y, and a radio protocol layer (radio protocols) of the bearer is located in X and Y; user plane data with an EPC or a next-generation core network ends at X, and resources provided by both X and Y are used. X may be an NR MgNB, an LTE MeNB, or an eLTE MeNB; Y may be an NR SgNB, an LTE SeNB, or an eLTE SeNB.

An X-Y SCG split bearer means that the master base station is X, the secondary base station is Y, and a radio protocol layer (radio protocols) of the bearer is located in X and Y; user plane data with an EPC or a next-generation core network ends at Y, but resources provided by X and Y are used. X may be an NR MgNB, an LTE MeNB, or an eLTE MeNB; Y may he an NR SgNB, an LTE SeNB, or an eLTE SeNB.

An X MCG bearer means that the MeNB is X, and the SeNB may be an NR SgNB, an LTE SeNB, or an eLTE SeNB. A radio protocol layer (radio protocols) of the bearer is located in X, and resources provided by X are used. X may be an NR MgNB, an LTE MeNB, or an eLTE MeNB.

An X SCG bearer means that the MeNB is X, and the SeNB may be an NR SgNB, an LTE SeNB, or an eLTE SeNB. A radio protocol layer (radio protocols) of the bearer is located in the SeNB, and resources provided by the SeNB are used. X may be an NR MgNB, an LTE MeNB, or an eLTE

An X MCG split bearer means that the MeNB is X, and the SeNB may be an NR SgNB, an LTE SeNB, or an eLTE SeNB. A radio protocol layer (radio protocols) of the bearer is located in X and the SeNB; user plane data with an EPC or a next-generation core network ends at X, and resources provided by both X and the SeNB are used. X may be an NR MgNB, an LTE MeNB, or an eLTE MeNB.

An X SCG split bearer means that the MeNB is X, and the SeNB may be an NR SgNB, an LTE SeNB, or an eLTE SeNB. A radio protocol layer (radio protocols) of the bearer is located in X and the SeNB, and resources provided by both X and the SeNB are used. X may be an NR MgNB, an LTE MeNB, or an eLTE MeNB.

An NR MCG bearer includes one or more of an NR-eLTE MCG bearer, an NR-NR MCG bearer, and an NR-LTE MCG bearer.

An LTE MCG bearer includes one or more of an LTE-eLTE MCG bearer, an LTE-NR MCG bearer, and an LTE-LTE MCG bearer.

An eLTE MCG bearer includes one or more of an eLTE-eLTE MCG bearer, an eLTE-NR MCG bearer, and an eLTE-LTE MCG bearer.

An NR SCG bearer includes one or more of an NR-eLTE SCG bearer, an NR-NR SCG bearer, and an NR-LIE SCG bearer.

An LTE SCG bearer includes one or more of an LTE-eLTE SCG bearer, an LTE-NR SCG bearer, and an LTE-LTE SCG bearer.

An eLTE SCG bearer includes one or more of an eLTE-eLTE SCG bearer, an eLTE-NR SCG bearer, and an eLTE-LTE SCG bearer.

An NR MCG split bearer includes one or more of an NR-eLTE MCG split bearer, an NR-NR MCG split bearer, and an NR-LIE MCG split bearer.

An LTE MCG split bearer includes one or more of an LTE-eLTE MCG split bearer, an LTE-NR MCG split bearer, and an LTE-LTE MCG split bearer.

An eLTE MCG split bearer includes one or more of an eLTE-eLTE MCG split bearer, an eLTE-NR MCG split bearer, and an eLTE-LTE MCG split bearer.

An NR SCG split bearer includes one or more of an NR-eLTE SCG split bearer, an NR-NR SCG split bearer, and an NR-LTE SCG split bearer.

An LTE SCG split bearer includes one or more of an LTE-eLTE SCG split bearer, an LTE-NR SCG split bearer, and an LTE-LTE SCG split bearer.

An eLTE SCG split bearer includes one or more of an eLTE-eLTE SCG split bearer, an eLTE-NR SCG split bearer, and an eLTE-LTE SCG split bearer.

If not specifically indicated, an MCG bearer in the present invention may include one or more of the following: an NR MCG bearer, an LTE MCG bearer, and an eLTE MCG bearer. An SCG bearer may include one or more of the following: an NR SCG bearer, an LTE SCG bearer, and an eLTE SCG bearer. An MCG split bearer may include one or more of the following: an NR MCG split bearer, an LTE MCG split bearer, and an eLTE MCG split bearer. An SCG split bearer may include one or more of the following: an NR SCG split bearer, an LTE SCG split bearer, and an eLTE SCG split bearer.

According to a transmission direction of data, the MCG split bearer may include one or both of an MCG split bearer not comprising PDCP uplink data transmission and an MCG split bearer of PDCP uplink data transmission. The SCG split bearer may also include one or both of an SCG split bearer not comprising PDCP uplink data transmission and an SCG split bearer of PDCP uplink data transmission. The MCG split bearer not comprising PDCP uplink data transmission means that downlink user plane data is transmitted using resources of both the MeNB and the SeNB. The MCG split bearer of PDCP uplink data transmission means that uplink user plane data is transmitted using resources of both the MeNB and the SeNB. The SCG split bearer not comprising PDCP uplink data transmission means that downlink user plane data is transmitted using resources of both the MeNB and the SeNB, The SCG split bearer of PDCP uplink data transmission means that uplink user plane data is transmitted using resources of both the MeNB and the SeNB. Herein, the PDCP may be an entity that implements data separation and/or aggregation in the MeNB and/or SeNB. That is, user plane data is processed by the PDCP entity, one part of the data is transmitted using resources provided by a base station where the PDCP entity is located, and the other part of the data is sent to and from another base station and is transmitted using resources provided by the base station. The entity that implements data separation and/or aggregation may have different names according to different types of MeNBs (for example, an NR MgNB, an LTE MeNB, and an eLTE MeNB); nevertheless, the entity is uniformly referred to as a PDCP entity in the present invention, and the entity can implement the data separation and/or aggregation function.

A master cell group (MCG) is a group of serving cells associated with the master base station, and includes a primary cell (PCell), and may further include one or more secondary cells (SCells). A secondary cell group (SCG) is a group of serving cells associated with the secondary base station, and includes a PSCell, and may further include one or more SCells. The PCell is a cell that operates at a primary carrier frequency; In this cell, UE performs an initial connection establishment process or starts a connection reestablishment process or indicates the cell as a PCell during a handover process. The PSCell is an SCG cell in which the UE performs random access when an SCG changing process is performed. The SCell is a cell that operates at the secondary carrier frequency; and the SCell can be configured after a radio resource control connection (RRC) is established and can provide additional radio resources.

It should be noted that the base station, the master base station, the secondary base station, the cell, the master cell group, the secondary cell group, the bearer, the core network, and so on may be named differently in different deployment scenarios. The present invention is also applicable when different names are used in different deployment scenarios.

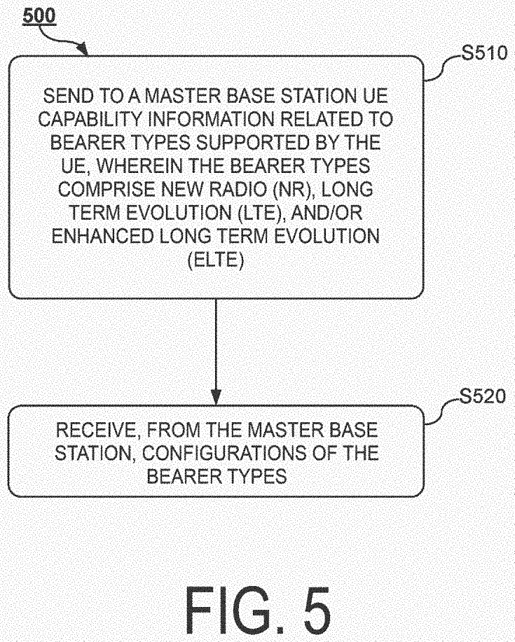

FIG. 5 is a flowchart of a method 500 used in user equipment (UE) according to an embodiment of the present disclosure. As shown in the figure, the method 500 includes the following steps.

Step S510: Send to a master base station UE capability information related to bearer types supported by the UE, wherein the bearer types comprise New Radio (NR), Long Term Evolution (LTE), and/or enhanced Long Term Evolution (eLTE).

Step S520: Receive, from the master base station, configurations of the bearer types.

The following gives specific exemplary situations of the supported bearer types indicated by the UP capability information in step S510. A message used by the UP for reporting the supported bearer types may include an NR radio resource control (RRC) message, an LTE radio resource control (RRC) message, or an eLTE radio resource control (RRC) message.

Situation 1: The data bearer type reported by the UE is irrelevant to the types of the master base station and secondary base station.

In this situation, the UE capability information indicates whether the UE supports one or more of the following:

a master cell group (MCG) split bearer not comprising Packet Data Convergence

Protocol (PDCP) uplink data transmission;

a secondary cell group (SCG) bearer;

an SCG split bearer not comprising PDCP uplink data transmission;

an MCG split bearer of PDCP uplink data transmission; and.

an SCG split bearer of PDCP uplink data transmission.

A radio protocol layer of the MCG split bearer is located in the master base station and the secondary base station; user plane data with a core network ends at the master base station, and resources of both the master base station and the secondary base station are used. A radio protocol layer of the SCG split bearer is located in the master base station and the secondary base station; user plane data with the core network ends at the secondary base station, and resources of both the master base station and the secondary base station are used. A radio protocol layer of the SCG bearer is located in the secondary base station, and resources of the secondary base station are used.

In this situation, the master base station may be one or more of an NR base station, an LTE base station, or an eLTE base station; the secondary base station may be one or more of an NR base station, an LTE base station, or an eLTE base station; and the core network may be one or more of an evolved packet core (EPC) or a next-generation core network.

The UE reports, to the eLTE and/or LTE and/or NR and/or EPC and/or next-generation core network, UE capability information of one or more DRB types supported by the LTE. The DRB types may include: an MCG split bearer not comprising PDCP uplink data transmission, an SCG bearer, an SCG split bearer not comprising PDCP uplink data transmission, an MCG split bearer of PDCP uplink data transmission, and an SCG split bearer of PDCP uplink data transmission.

Specifically, in one embodiment, the UP capability indicates whether the UE supports an MCG split bearer not comprising PDCP uplink data transmission. The MCG split bearer may include one or more of an NR MCG split bearer, an LTE MCG split bearer, and an eLTE MCG split bearer. The master base station corresponding to the MCG split bearer not comprising PDCP uplink data transmission may be a gNB, an LTE eNB, or an eLTE eNB; and the corresponding secondary base station may be a gNB, an LTE eNB, or an eLTE eNB.

In one embodiment, the UE capability indicates whether the UE supports an SCG bearer. The SCG bearer may include one or more of an NR SCG bearer, an LTE SCG bearer, and an eLTE SCG bearer. The master base station corresponding to the SCG bearer may be a gNB, a LTE eNB, or an eLTE eNB; and the corresponding secondary base station may be a gNB, an LTE eNB, or an eLTE eNB.

In one embodiment, the LTE capability indicates whether the UE supports an SCG split bearer not comprising PDCP uplink data transmission. The SCG split bearer may include one or more of an NR SCG split bearer not comprising PDCP uplink data transmission, an LTE SCG split bearer not comprising PDCP uplink data transmission, and an eLTE SCG split bearer not comprising PDCP uplink data transmission. The master base station corresponding to the SCG split bearer not comprising PDCP uplink data transmission may be a gNB, an LTE eNB, or an eLTE; and the corresponding secondary base station may be a gNB, an um eNB, or an eLTE eNB.

In one embodiment, the UE capability indicates whether the UE supports an MCG split bearer of PDCP uplink data transmission. The MCG split bearer of PDCP uplink data transmission may include one or more of an NR MCG split bearer of PDCP uplink data transmission, an LTE MCG split bearer of PDCP uplink data transmission, and an eLTE MCG split bearer of PDCP uplink data transmission. The master base station corresponding to the MCG split bearer of PDCP uplink data transmission may be a gNB, an LTE eNB, or an eLTE, eNB; and the corresponding secondary base station may be a gNB, an LTE eNB, or an eLTE eNB.

In one embodiment, the UE capability indicates whether the UE supports an SCG split bearer of PDCP uplink data transmission. The SCG split bearer of PDCP uplink data transmission may include one or more of an NR SCG split bearer of PDCP uplink data transmission, an LTE SCG split bearer of PDCP uplink data transmission, and an eLTE SCG split bearer of PDCP uplink data transmission. The master base station corresponding to the SCG split bearer of PDCP uplink data transmission may be a gNB, an LTE eNB, or an eLTE eNB; and the corresponding secondary base station may be a gNB, an LTE eNB, or an eLTE eNB.

It should be noted that the UE capability can simultaneously indicate one or more of the capabilities listed in the above embodiments.

Situation II: An NR gNB serves as the master base station, which does not need to know whether the UE supports the use of an LTE eNB or an eLTE eNB as the master base station; and the reported data bearer type is irrelevant to the type of the secondary base station.

In this situation, the UE capability information indicates whether the UE supports one or more of the following:

an MCG split bearer not comprising PDCP uplink data transmission and using an NR base station as the master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station.

A radio protocol layer of the MCG split bearer is located in the master base station and the secondary base station; user plane data with a core network ends at the master base station, and resources of both the master base station and the secondary base station are used. A radio protocol layer of the SCG split bearer is located in the master base station and the secondary base station; user plane data with the core network ends at the secondary base station, and resources of both the master base station and the secondary base station are used. A radio protocol layer of the SCG bearer is located in the secondary base station, and resources of the secondary base station are used.

In this situation, the master base station is an NR base station; the secondary base station may be an NR base station, an LTE base station, or an eLTE base station; and the core network may be a next-generation core network.

The UE reports, to the NR base station and/or next-generation core network, UE capability information of one or more DRB types supported by the UE.

Specifically, in one embodiment, the UE capability indicates whether NR of the UE supports dual-connection (or multi-connection). That is, the gNB serves as the master base station, and the secondary base station may be a gNB, an eLTE eNB, or an LTE eNB.

In one embodiment, the UE capability indicates whether NR of the UE supports an NR MCG split bearer not comprising PDCP uplink data transmission. The NR MCG split bearer not comprising PDCP uplink data transmission may include one or more of an NR-LTE MCG split bearer not comprising PDCP uplink data transmission, an NR-eLTE MCG split bearer not comprising PDCP uplink data transmission, and an NR-NR MCG split bearer not comprising PDCP uplink data transmission. The master base station corresponding to the NR MCG split bearer not comprising PDCP uplink data transmission is a gNB, and the secondary base station may be a gNB, an LIT eNB, or an eLTE eNB.

In one embodiment, the UE capability indicates whether the UE supports an NR SCG bearer. The SCG bearer may include one or more of an NR-LTE SCG bearer, an NR-eLTE SCG bearer, and an NR-NR SCG bearer. The master base station corresponding to the SCG bearer is a gNB, and the secondary base station may be a gNB, an LTE eNB, or an eLTE eNB.

In one embodiment, the UP capability indicates whether the UE supports an NR SCG split bearer not comprising PDCP uplink data transmission. The bearer may include one or more of an NR-NR SCG split bearer not comprising PDCP uplink data transmission, an NR-LTE SCG split bearer not comprising PDCP uplink data transmission, and an NR-eLTE SCG split bearer not comprising PDCP uplink data transmission. The master base station corresponding to the NR SCG split bearer not comprising PDCP uplink data transmission is a gNB, and the secondary base station may be a gNB, an LIE eNB, or an eLTE eNB.

In one embodiment, the UE capability indicates whether the UE supports an NR MCG split bearer of PDCP uplink data transmission. The bearer may include one or more of an NR-NR MCG split bearer of PDCP uplink data transmission, an NR-LTE MCG split bearer of PDCP uplink data transmission, and an NR-eLTE MCG split bearer of PDCP uplink data transmission. The master base station corresponding to the NR MCG split bearer of PDCP uplink data transmission is a gNB, and the secondary base station may be a gNB, an LTE eNB, or an eLTE eNB.

In one embodiment, the UE capability indicates whether the UE supports an NR SCG split bearer of PDCP uplink data transmission. The bearer may include one or more of an NR-NR SCG split bearer of PDCP uplink data transmission, an NR-LTE SCG split bearer of PDCP uplink data transmission, and an NR-eLTE SCG split bearer of PDCP uplink data transmission. The master base station corresponding to the NR SCG split bearer of PDCP uplink data transmission is a gNB, and the secondary base station may be a gNB, an LTE eNB, or an eLTE eNB.

It should be noted that the UE capability can simultaneously indicate one or more of the capabilities listed in the above embodiments.

Situation III: An NR gNB serves as the master base station, which does not need to know whether the UE supports the use of an LTE eNB or an eLTE eNB as the master base station; the reported data bearer type, however, is related to the type of the secondary base station.

In this situation, the UE capability information indicates whether UE supports one or more of the following:

an MCG split bearer not comprising PDCP uplink data transmission and using an NR base station as the master base station and an LTE base station as the secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station as the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station.

A radio protocol layer of the MCG split bearer is located in the master base station and the secondary base station; user plane data with a core network ends at the master base station, and resources of both the master base station and the secondary base station are used. A radio protocol layer of the SCG split bearer is located in the master base station and the secondary base station; user plane data with the core network ends at the secondary base station, and resources of both the master base station and the secondary base station are used. A radio protocol layer of the SCG bearer is located in the secondary base station, and resources of the secondary base station are used.

In this situation, the master base station is an NR base station; the secondary base station may be an NR base station, an LTE base station, or an eLTE base station; and the core network may be a next-generation core network.

The UE reports, to the NR and/or next-generation core network, UE capability information of one or more DRB types supported by the UE.

Specifically, in one embodiment, the UE capability indicates whether NR of the UE supports dual-connection (or multi-connection). That is, the NR gNB serves as the master base station, and the secondary base station may be a gNB, an eLTE eNB, or an LTE eNB.

In one embodiment, the UE capability indicates whether NR of the UE supports an NR-LTE MCG split bearer not comprising PDCP uplink data transmission. The master base station corresponding to the NR-LTE MCG split bearer not comprising PDCP uplink data transmission is a gNB, and the secondary base station is an LTE eNB.

In one embodiment, the LTE capability indicates whether NR of the UE supports an NR-eLTE MCG split bearer not comprising PDCP uplink data transmission. The master base station corresponding to the NR-eLTE MCG split bearer not comprising PDCP uplink data transmission is a gNB, and the secondary base station is an eLTE eNB.

In one embodiment, the UE capability indicates whether NR of the UE supports an NR-NR MCG split bearer not comprising PDCP uplink data transmission. The master base station corresponding to the NR-NR MCG split bearer not comprising PDCP uplink data transmission is a gNB, and the secondary base station is a gNB.

In one embodiment, the UE capability indicates whether the UE supports an NR-NR SCG bearer. The master base station corresponding to the NR-NR SCG bearer is a gNB, and the secondary base station is a gNB.

In one embodiment, the UE capability indicates whether the UE supports an NR-LTE SCG bearer. The master base station corresponding to the NR-LTE SCG bearer is a gNB, and the secondary base station is an LTE eNB.

In one embodiment, the UE capability indicates whether the UE supports an NR-eLTE SCG bearer. The master base station corresponding to the NR-eLTE SCG bearer is a gNB, and the secondary base station is an eLTE eNB.

In one embodiment, the UE capability indicates whether NR of the UE supports an NR-LTE MCG split bearer of PDCP uplink data transmission. The master base station corresponding to the NR-LTE MCG split bearer of PDCP uplink data transmission is a gNB, and the secondary base station is an LTE eNB.

In one embodiment, the UE capability indicates whether NR of the UE supports an NR-eLTE MCG split bearer of PDCP uplink data transmission. The master base station corresponding to the NR-LTE MCG split bearer of PDCP uplink data transmission is a gNB, and the secondary base station is an eLTE eNB.

In one embodiment, the UE capability indicates whether NR of the UE supports an NR-NR MCG split bearer of PDCP uplink data transmission. The master base station corresponding to the NR-NR MCG split bearer of PDCP uplink data transmission is a gNB, and the secondary base station is a gNB.

In one embodiment, the UE capability indicates whether NR of the UE supports an NR-LTE SCG split bearer not comprising PDCP uplink data transmission. The master base station corresponding to the NR-LTE SCG split bearer not comprising PDCP uplink data transmission is an NR gNB, and the secondary base station is an LTE eNB.

In one embodiment, the UE capability indicates whether NR of the UE supports an NR-eLTE SCG split bearer not comprising PDCP uplink data transmission. The master base station corresponding to the NR-eLTE SCG split bearer not comprising PDCP uplink data transmission is a gNB, and the secondary base station is an eLTE eNB.

In one embodiment, the UE capability indicates whether NR of the UE supports an NR-NR SCG split bearer not comprising PDCP uplink data transmission. The master base station corresponding to the NR-NR SCG split bearer not comprising PDCP uplink data transmission is a gNB, and the secondary base station is a gNB.

In one embodiment, the UE capability indicates whether NR of the UE supports an NR-LTE SCG split bearer of PDCP uplink data transmission. The master base station corresponding to the NR-LTE SCG split bearer of PDCP uplink data transmission is a gNB, and the secondary base station is an LTE eNB.

In one embodiment, the UE capability indicates whether NR of the UE supports an NR-eLTE SCG split bearer of PDCP uplink data transmission. The master base station corresponding to the NR-eLTE SCG split bearer of PDCP uplink data transmission is a gNB, and the secondary base station is an eLTE eNB.

In one embodiment, the UE capability indicates whether NR of the UE supports an NR-NR SCG split bearer of PDCP uplink data transmission. The master base station corresponding to the NR-NR SCG split bearer of PDCP uplink data transmission is a gNB, and the secondary base station is a gNB.

It should be noted that the UE capability can indicate one or more of the capabilities listed in the above embodiments.

Situation IV: An LTE eNB serves as the master base station, which does not need to know whether the UE supports the use of a gNB or an eLTE eNB as the master base station; and the reported data bearer type is irrelevant to the type of the secondary base station.

In this situation, the UE capability information indicates whether the UE supports one or more of the following:

an MCG split bearer not comprising PDCP uplink data transmission and using an LTE base station as the master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission acing an LTE base station as the master base station.

A radio protocol layer of the MCG split bearer is located in the master base station and the secondary base station; user plane data with a core network ends at the master base station, and resources of both the master base station and the secondary base station are used. A radio protocol layer of the SCG split bearer is located in the master base station and the secondary base station; user plane data with the core network ends at the secondary base station, and resources of both the master base station and the secondary base station are used. A radio protocol layer of the SCG bearer is located in the secondary base station, and resources of the secondary base station are used.

In this situation, the master base station may be an LTE base station; the secondary base station may be an NR base station, an LTE base station, or an eLTE base station; and the core network may be an EPC.

The UE reports, to the LTE eNB and/or EPC, UE capability information of one or more DRB types supported by the UE.

Specifically, in one embodiment, the UE capability indicates whether LTE of the UE supports dual-connection (or multi-connection). That is, the LTE eNB serves as the master base station, and the secondary base station may be a gNB, an eLTE eNB, or an eNB.

In one embodiment, the UE capability indicates whether the UE supports an LTE MCG split bearer not comprising PDCP uplink data transmission. The bearer may include one or more of an LTE-NR MCG bearer, an LTE-LTE MCG bearer, and an LTE-eLTE MCG bearer. The master base station corresponding to the LTE MCG split bearer not comprising PDCP uplink data transmission is an LTE eNB, and the secondary base station may be a gNB, an LTE eNB, or an eLTE eNB.

In one embodiment, the UE capability indicates whether the UP supports an LTE SCG bearer. The bearer may include one or more of an LTE-NR SCG bearer, an LTE-LTE SCG bearer, and an LTE-eLTE SCG bearer. The master base station corresponding to the SCG bearer is a gNB, and the secondary base station may be a gNB, an LTE eNB, or an eLTE eNB.

In one embodiment, the UE capability indicates whether the UE supports an LTE SCG split bearer not comprising PDCP uplink data transmission. The SCG split bearer may include one or more of an LTE-NR SCG split bearer not comprising PDCP uplink data transmission, an LTE-LTE SCG split bearer not comprising PDCP uplink data transmission, and an LTE-eLTE SCG split bearer not comprising PDCP uplink data transmission. The master base station corresponding to the LTE SCG split bearer not comprising PDCP uplink data transmission is an LTE eNB, and the secondary base station may be a gNB, an LTE eNB, or an eLTE eNB.

In one embodiment, the UE capability indicates whether the UE supports an LTE MCG split bearer of PDCP uplink data transmission. The bearer may include one or more of an LTE-NR MCG split bearer of PDCP uplink data transmission, an LTE-LTE MCG split bearer of PDCP uplink data transmission, and an LTE-eLTE MCG split bearer of PDCP uplink data transmission. The master base station corresponding to the LTE MCG split bearer of PDCP uplink data transmission is an LTE eNB, and the secondary base station may be a gNB, an LTE eNB, or an eLTE eNB.

In one embodiment, the UE capability indicates whether the UE supports an LTE SCG split bearer of PDCP uplink data transmission. The LTE-SCG split bearer of PDCP uplink data transmission may include one or more of an LTE-NR SCG split bearer of PDCP uplink data transmission, an LTE-LTE SCG split bearer of PDCP uplink data transmission, and an LTE-eLTE SCG split bearer of PDCP uplink data transmission. The master base station corresponding to the LTE SCG split bearer of PDCP uplink data transmission is an LTE eNB, and the secondary base station may be a gNB, an LTE eNB, or an eLTE eNB.

It should be noted that the UE capability can indicate one or more of the capabilities listed in the above embodiments.

Situation V: An LTE eNB serves as the master base station, which does not need to know whether the UE supports the use of a gNB or an eLTE eNB as the master base station; the reported data bearer type, however, is related to the type of the secondary base station.

In this situation, the UE capability information indicates whether the UE supports one or more of the following:

an MCG split bearer not comprising PDCP uplink data transmission and using an LTE base station as the master base station and an LTE base station as the secondary base station;

an MCG split bearer not comprising PDCP uplink data transmission and using an LTE base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LTE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station.

A radio protocol layer of the MCG split bearer is located in the master base station and the secondary base station; user plane data with a core network ends at the master base station, and resources of both the master base station and the secondary base station are used. A radio protocol layer of the SCG split bearer is located in the master base station and the secondary base station; user plane data with the core network ends at the secondary base station, and resources of both the master base station and the secondary base station are used. A radio protocol layer of the SCG bearer is located in the secondary base station, and resources of the secondary base station are used.

In this situation, the master base station is an LTE base station; the secondary base station may be an NR base station, an LTE base station, or an eLTE base station; and the core network may be an EPC.

The UE, reports, to the LTE and/or EPC, UE capability information of one or more DRB types supported by the UE.

Specifically, in one embodiment, the UE capability indicates whether LTE of the UE supports dual-connection (or multi-connection). That is, the LTE eNB serves as the master base station, and the secondary base station may be a gNB, an eLTE eNB, or an LTE eNB.

In one embodiment, the UE capability indicates whether the UE supports an LTE-NR MCG split bearer not comprising PDCP uplink data transmission. The master base station corresponding to the LTE-NR MCG split bearer not comprising PDCP uplink data transmission is an LTE eNB, and the secondary base station is a gNB.

In one embodiment, the UE capability indicates whether the UE supports an LTE-eLTE MCG split bearer not comprising PDCP uplink data transmission. The master base station corresponding to the LTE-eLTE MCG split bearer not comprising PDCP uplink data transmission is an LTE eNB, and the secondary base station is an eLTE

In one embodiment, the UE capability indicates whether the UE supports an LTE-LTE MCG split bearer not comprising PDCP uplink data transmission. The master base station corresponding to the LTE-LTE MCG split bearer not comprising PDCP uplink data transmission is an LTE eNB, and the secondary base station is an LTE eNB.

In one embodiment, the UE capability indicates whether the UE supports an LTE-LTE SCG bearer. The master base station corresponding to the LTE-LTE SCG bearer is an LTE eNB, and the secondary base station is an LTE eNB.

In one embodiment, the UE capability indicates whether the UE supports an LTE-eLTE SCG bearer. The master base station corresponding to the LTE-eLTE SCG bearer is an LTE eNB, and the secondary base station is an eLTE eNB.

In one embodiment, the LTE capability indicates whether the UE supports an LTE-NR SCG bearer. The master base station corresponding to the LTE-NR SCG bearer is an LTE eNB, and the secondary base station is a gNB.

In one embodiment, the LTE capability indicates whether the UE supports an LTE-NR MCG split bearer of PDCP uplink data transmission. The master base station corresponding to the LTE-NR MCG split bearer of PDCP uplink data transmission is an LTE eNB, and the secondary base station is a gNB.

In one embodiment, the LTE capability indicates whether the UE supports an LTE-eLTE MCG split bearer of PDCP uplink data transmission. The master base station corresponding to the LTE-eLTE MCG split bearer of PDCP uplink data transmission is an LTE eNB, and the secondary base station is an eLTE eNB.

In one embodiment, the UE capability indicates whether the UE supports an LTE-LTE MCG split bearer of PDCP uplink data transmission. The master base station corresponding to the LTE-LTE MCG split bearer of PDCP uplink data transmission is an LTE eNB, and the secondary base station is an LTE eNB.

In one embodiment, the UE capability indicates whether the UE supports an LTE-LTE SCG split bearer not comprising PDCP uplink data transmission, The master base station corresponding to the LTE-LTE SCG split bearer not comprising PDCP uplink data transmission is an LTE eNB, and the secondary base station is an un eNB.

In one embodiment, the UE capability indicates whether the UE supports an LTE-eLTE SCG split bearer not comprising PDCP uplink data transmission. The master base station corresponding to the LTE-eLTE SCG split bearer not comprising PDCP uplink data transmission is an LTE eNB, and the secondary base station is an eLTE eNB.

In one embodiment, the UE capability indicates whether the UE supports an LTE-NR SCG split bearer not comprising PDCP uplink data transmission. The master base station corresponding to the LTE-NR SCG split bearer not comprising PDCP uplink data transmission is an LTE eNB, and the secondary base station is a gNB.

In one embodiment, the LTE capability indicates whether the UE supports an LTE-LTE SCG split bearer of PDCP uplink data transmission. The master base station corresponding to the LTE-LTE SCG split bearer of PDCP uplink data transmission is an LTE eNB, and the secondary base station is an LTE eNB.

In one embodiment, the LTE capability indicates whether the UE supports an LTE-eLTE SCG split bearer of PDCP uplink data transmission. The master base station corresponding to the LTE-eLTE SCG split bearer of PDCP uplink data transmission is art LTE eNB, and the secondary base station is an eLTE eNB.

In one embodiment, the UE capability indicates whether the UE supports an LTE-NR SCG split bearer of PDCP uplink data transmission. The master base station corresponding to the LTE-NR SCG split bearer of PDCP uplink data transmission is an LTE eNB, and the secondary base station is a gNB.

It should be noted that the UE capability can indicate one or more of the capabilities listed in the above embodiments.

Situation VI: An eLTE eNB serves as the master base station, which does not need to know whether the UE supports the use of a gNB or an eLTE eNB as the master base station; and the reported data bearer type is irrelevant to the type of the secondary base station.

In this situation, the UE capability information indicates whether the UE supports one or more of the following:

an MCG split bearer not comprising PDCP uplink data transmission and using an eLTE base station as the master base station;

an SCG bearer using an eLTE base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station.

A radio protocol layer of the MCG split bearer is located in the master base station and the secondary base station; user plane data with a core network ends at the master base station, and resources of both the master base station and the secondary base station are used. A radio protocol layer of the SCG split bearer is located in the master base station and the secondary base station; user plane data with the core network ends at the secondary base station, and resources of both the master base station and the secondary base station are used. A radio protocol layer of the SCG bearer is located in the secondary base station, and resources of the secondary base station are used.

In this situation, the master base station is an eLTE base station; the secondary base station may be an NR base station, an LTE base station, or an eLTE base station; and the core network may be a next-generation core network.

The UE reports, to the eLTE eNB and/or next-generation core network, UE capability information of one or more DRB types supported by the UP.

Specifically, in one embodiment, the UE capability indicates whether eLTE of the UP supports dual-connection (or multi-connection). That is, the eLTE eNB serves as the master base station, and the secondary base station may be a gNB, an eLTE eNB, or an LTE eNB.

In one embodiment, the UE capability indicates whether eLTE of the UE supports an eLTE MCG split bearer not comprising PDCP uplink data transmission. The eLTE MCG bearer not comprising PDCP uplink transmission may include one or more of an eLTE-NR MCG bearer, an eLTE-LTE MCG bearer, and an eLTE-eLTE MCG bearer. The master base station corresponding to the eLTE MCG split bearer not comprising PDCP uplink data transmission is an eLTE eNB, and the secondary base station may be a gNB, an LTE eNB, or an eLTE eNB.

In one embodiment, the UE capability indicates whether the UE supports an eLTE SCG bearer. The eLTE SCG bearer may include one or more of an eLTE-NR SCG bearer, an eLTE-LTE SCG bearer, and an eLTE-eLTE SCG bearer. The master base station corresponding to the eLTE SCG bearer is an eLTE eNB, and the secondary base station may be a gNB, an LTE eNB, or an eLTE eNB.

In one embodiment, the UE capability indicates whether the UP supports an eLTE SCG split bearer not comprising PDCP uplink data transmission. The bearer may include one or more of an eLTE-NR SCG split bearer not comprising PDCP uplink data transmission, an eLTE-LTE SCG split bearer not comprising PDCP uplink data transmission, and an eLTE-eLTE SCG split bearer not comprising PDCP uplink data transmission. The master base station corresponding to the eLTE SCG split bearer not comprising PDCP uplink data transmission is an eLTE eNB, and the secondary base station may be a gNB, an LTE eNB, or an eLTE eNB.

In one embodiment, the UE capability indicates whether the UE supports an eLTE MCG split bearer of PDCP uplink data transmission. The bearer may include one or more of an eLTE-NR MCG split bearer of PDCP uplink data transmission, an eLTE-LTE MCG split bearer of PDCP uplink data transmission, and an eLTE-eLTE MCG split bearer of PDCP uplink data transmission. The master base station corresponding to the eLTE MCG split bearer of PDCP uplink data transmission is an eLTE eNB, and the secondary base station may be a gNB, an LTE eNB, or an eLTE eNB.

In one embodiment, the UE capability indicates whether the UE supports an eLTE SCG split bearer of PDCP uplink data transmission. The eLTE SCG split bearer of PDCP uplink data transmission may include one or more of an eLTE-NR SCG split bearer of PDCP uplink data transmission, an eLTE-LTE SCG split bearer of PDCP uplink data transmission, and an eLTE-eLTE SCG split bearer of PDCP uplink data transmission. The master base station corresponding to the eLTE SCG split bearer of PDCP uplink data transmission is an eLTE eNB, and the secondary base station may be a gNB, an LTE eNB, or an eLTE eNB.

It should be noted that the UE capability can indicate one or more of the capabilities listed in the above embodiments.

Situation VII: An eLTE eNB serves as the master base station, which does not need to know whether the UE supports the use of a gNB or an LTE eNB as the master base station; the reported data bearer type, however, is related to the type of the secondary base station.

In this situation, the UE capability information indicates whether the UE supports one or more of the following:

an MCG split bearer not comprising PDCP uplink data transmission and using an eLTE base station as the master base station and an LTE base station as the secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an LTE base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an LTE base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an LTE base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station.

A radio protocol layer of the MCG split bearer is located in the master base station and the secondary base station; user plane data with a core network ends at the master base station, and resources of both the master base station and the secondary base station are used. A radio protocol layer of the SCG split bearer is located in the master base station and the secondary base station; user plane data with the core network ends at the secondary base station, and resources of both the master base station and the secondary base station are used. A radio protocol layer of the SCG bearer is located in the secondary base station, and resources of the secondary base station are used.

In this situation, the master base station is an eLTE base station; the secondary base station may be an NR base station, an LTE base station, or an eLTE base station; and the core network may be a next-generation core network.

The LTE reports, to the eLTE and/or next-generation core network, LTE capability information of one or more DRB types supported by the UE.

Specifically, in one embodiment, the UE capability indicates whether eLTE of the UE supports dual-connection (or multi-connection). That is, the eLTE eNB serves as the master base station, and the secondary base station may be a gNB, an eLTE eNB, or an LTE

In one embodiment, the UE capability indicates whether the UE supports an eLTE-NR MCG split bearer not comprising PDCP uplink data transmission. The master base station corresponding to the eLTE-NR MCG split bearer not comprising PDCP uplink data transmission is an eLTE eNB, and the secondary base station is a gNB.

In one embodiment, the UE capability indicates whether the UE supports an eLTE-eLTE MCG split bearer not comprising PDCP uplink data transmission. The master base station corresponding to the eLTE-eLTE MCG split bearer not comprising PDCP uplink data transmission is an eLTE eNB, and the secondary base station is an eLTE eNB.

In one embodiment, the LTE capability indicates whether the UP supports an eLTE-LTE MCG split bearer not comprising PDCP uplink data transmission. The master base station corresponding to the eLTE-LTE MCG split bearer not comprising PDCP uplink data transmission is an eLTE eNB, and the secondary base station is an LTE eNB.

In one embodiment, the UE capability indicates whether the UE supports an eLTE-LTE SCG bearer. The master base station corresponding to the bearer is an eLTE eNB, and the secondary base station is an LTE eNB.

In one embodiment, the LTE capability indicates whether the UP supports an eLTE-eLTE SCG bearer. The master base station corresponding to the bearer is an eLTE. eNB, and the secondary base station is an eLTE eNB.

In one embodiment, the UE capability indicates whether the UE supports an eLTE-NR SCG bearer. The master base station corresponding to the NR-SCG bearer is an eLTE; eNB, and the secondary base station is a gNB.

In one embodiment, the UE capability indicates whether the UE supports an eLTE-NR MCG split bearer of PDCP uplink data transmission. The master base station corresponding to the eLTE-NR MCG split bearer of PDCP uplink data transmission is an eLTE eNB, and the secondary base station is a gNB.

In one embodiment, the UE capability indicates whether the UE supports an eLTE-eLTE MCG split bearer of PDCP uplink data transmission. The master base station corresponding to the eLTE-eLTE MCG split bearer of PDCP uplink data transmission is an eLTE eNB, and the secondary base station is an eLTE eNB.

In one embodiment, the UE capability indicates whether the UE supports an eLTE-LTE MCG split bearer of PDCP uplink data transmission. The master base station corresponding to the eLTE-LTE MCG split bearer of PDCP uplink data transmission is an eLTE eNB, and the secondary base station is an LTE eNB.

In one embodiment, the UE capability indicates whether the UE supports an eLTE-LTE SCG split bearer not comprising PDCP uplink data transmission. The master base station corresponding to the eLTE-LTE SCG split bearer not comprising PDCP uplink data transmission is an eLTE eNB, and the secondary base station is an LTE eNB.

In one embodiment, the UE capability indicates whether the UE supports an eLTE-eLTE SCG split bearer not comprising PDCP uplink data transmission. The master base station corresponding to the eLTE-eLTE SCG split bearer not comprising PDCP uplink data transmission is an eLTE eNB, and the secondary base station is an eLTE eNB.

In one embodiment, the UE capability indicates whether the UE supports an eLTE-NR SCG split bearer not comprising PDCP uplink data transmission. The master base station corresponding to the eLTE-NR SCG split bearer not comprising PDCP uplink data transmission is an eLTE eNB, and the secondary base station is a gNB.

In one embodiment, the UE capability indicates whether the UE supports an eLTE-LTE SCG split bearer of PDCP uplink data transmission. The master base station corresponding to the eLTE-LTE SCG split bearer of PDCP uplink data transmission is an eLTE eNB, and the secondary base station is an LTE eNB.

In one embodiment, the UE capability indicates whether the UE supports an eLTE-eLTE SCG split bearer of PDCP uplink data transmission. The master base station corresponding to the eLTE-eLTE SCG split bearer of PDCP uplink data transmission is an eLTE eNB, and the secondary base station is an eLTE eNB.

In one embodiment, the LTE capability indicates whether the UE supports an eLTE-NR SCG split bearer of PDCP uplink data transmission. The master base station corresponding to the eLTE-NR SCG split bearer of PDCP uplink data transmission is an eLTE eNB, and the secondary base station is a gNB.

It should be noted that the UE capability can indicate one or more of the capabilities listed in the above embodiments.

In the present invention, the UE can simultaneously indicate one or more capabilities in the embodiments listed in Situations I to VII. The UE can also simultaneously indicate one or more capabilities in the embodiments listed in Situations II, IV, and VI. The UE can also simultaneously indicate one or more capabilities in the embodiments listed in Situations III, V, and VII.

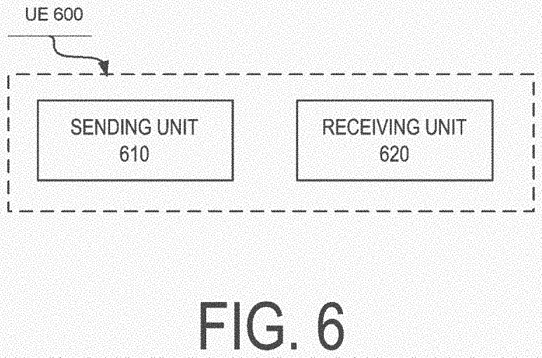

In accordance with the method 500 described above, the present disclosure provides user equipment (UE). FIG. 6 is a block diagram of UE 600 according to an embodiment of the present disclosure. As shown in the figure, the UP 600 includes:

a sending unit 610, configured to send to a master base station UE capability information related to bearer types supported by the UE, wherein the bearer types comprise New Radio (NR); Long Term Evolution (LTE), and/or enhanced Long Term Evolution (eLTE); and

a receiving unit 620, configured to receive, from the master base station, configurations of the bearer types.

In one embodiment, the UP capability information indicates whether the UE supports one or more of the following:

a master cell group (MCG) split bearer not comprising Packet Data Convergence Protocol (PDCP) uplink data transmission;

a secondary cell group (SCG) bearer;

an SCG split bearer not comprising uplink PDCP data transmission;

an MCG split bearer of PDCP uplink data transmission; and

an SCG split bearer of PDCP uplink data transmission,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station may be an NR base station, an LTE base station, or an eLTE base station; the secondary base station may be an NR base station, an LTE base station, or an eLTE base station; and the core network may be an evolved packet core (EPC) or a next-generation core network.

In one embodiment, the UE capability information indicates whether the UE supports one or more of the following:

an MCG split bearer not comprising PDCP uplink data transmission and using an NR base station as the master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an NR base station as the master base station and an LTE base station as a secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station as the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station; the secondary base station may be an NR base station, an LTE base station, or an eLTE base station; and the core network may be a next-generation core network.

In one embodiment, the UE capability information indicates whether the UE supports one or more of the following:

art MCG split bearer not comprising PDCP uplink data transmission and using an LTE base station as the master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission using an LTE base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an LTE base station as the master base station and an LTE base station as a secondary base station;

an MCG split bearer not comprising PDCP uplink data transmission and using an LTE base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LTE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an LTE base station; the secondary base station may be an NR base station, an LTE base station, or an eLTE base station; and the core network may be an EPC.

In one embodiment, the UE capability information indicates whether the UE supports one or more of the following:

an MCG split bearer not comprising PDCP uplink data transmission and using an eLTE base station as the master base station;

an SCG bearer using an eLTE base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an eLTE base station as the master base station and an LTE base station as a secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an LTE base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an LTE base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an LTE base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an eLTE base station; the secondary base station may be an NR base station, an LTE base station, or an eLTE base station; and the core network may be a next-generation core network.

In the present invention, the sending unit 610 can simultaneously indicate one or more capabilities in the embodiments listed above.

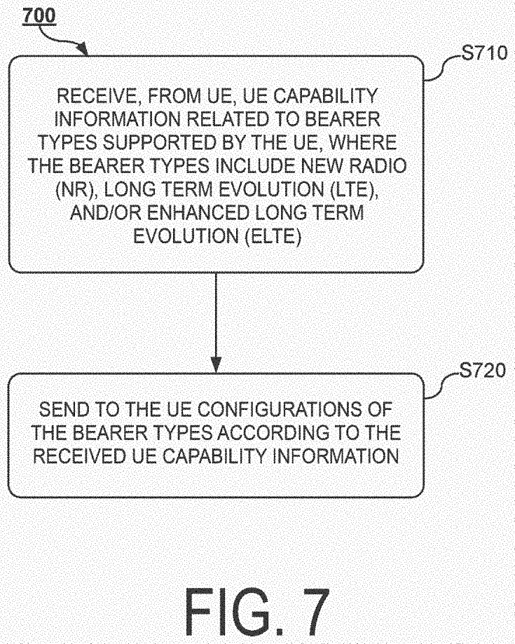

In accordance with the method 500 described above, the present disclosure further provides a method used in a base station. FIG. 7 is a flowchart of a method 700 used in a base station according to an embodiment of the present disclosure. As shown in the figure, the method 700 includes the following steps.

Step S710: Receive, from UE, UE capability information related to bearer types supported by the UE, where the bearer types include New Radio (NR), Long Term Evolution (LIE), and/or enhanced Long Term Evolution (eLTE).

Step S720: Send to the UE configurations of the bearer types according to the received UE capability information.

In one embodiment, the UE capability information indicates whether the UE supports one or more of the following:

a master cell group (MCG) split bearer not comprising Packet Data Convergence Protocol (PDCP) uplink data transmission;

a secondary cell group (SCG) bearer;

an SCG split bearer not comprising PDCP uplink data transmission;

an MCG split bearer of PDCP uplink data transmission; and

an SCG split bearer of PDCP uplink data transmission,

where a radio protocol layer of the MCG split bearer is located in a master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station may be an NR base station, an LTE base station, or an eLTE base station; the secondary base station may be an NR base station, an LTE base station, or an eLTE base station; and the core network may be an evolved packet core (EPC) or a next-generation core network.

In one embodiment, the UE capability information indicates whether the UE supports one or more of the following:

an MCG split bearer not comprising PDCP uplink data transmission and using an NR base station as a master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an NR base station as a master base station and an LTE base station as a secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station as the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station; the secondary base station may be an NR base station, an LTE base station, or an eLTE base station; and the core network may be a next-generation core network.

In one embodiment, the UE capability information indicates whether the UE supports one or more of the following:

an MCG split bearer not comprising PDCP uplink data transmission and using an LTE base station as a master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission using an LTE, base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an LTE base station as a master base station and an LTE base station as a secondary base station;

an MCG split bearer not comprising PDCP uplink data transmission and using an base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LIE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an LTE base station; the secondary base station may be an NR base station, an LTE base station, or an eLTE base station; and the core network may be an EPC.

In one embodiment, the UE capability information indicates whether the UE supports one or more of the following:

an MCG split bearer not comprising PDCP uplink data transmission and using an eLTE base station as a master base station;

an SCG bearer using an eLTE base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an eLTE base station as a master base station and an LTE base station as a secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an LTE base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an LTE base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an um base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an eLTE base station; the secondary base station may be an NR base station, an LTE base station, or an eLTE base station; and the core network may be a next-generation core network.

In the method 500 described above, the UE can simultaneously indicate one or more capabilities in the embodiments listed above. The eNB can configure for the UE one or more bearers corresponding to one or more capabilities in the embodiments listed above.

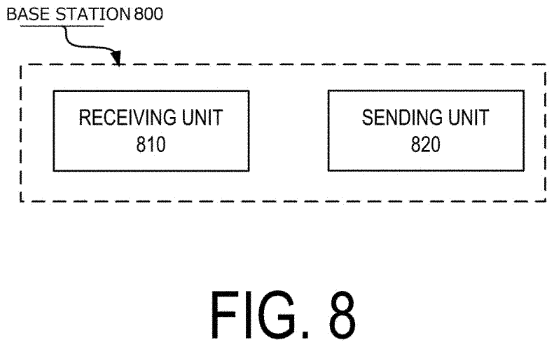

In accordance with the method 500 described above, the present disclosure provides a base station. FIG. 8 is a block diagram of a base station 800 according to an embodiment of the present disclosure. As shown in the figure, the base station 800 includes:

a receiving unit 810, configured to receive, from UE, UE capability information related to bearer types supported by the UE, wherein the bearer types comprise New Radio (NR), Long Term Evolution (LTE), and/or enhanced Long Term Evolution (eLTE); and

a sending unit 820, configured to send to the UE configurations of the bearer types according to the received UE capability information.

In one embodiment, the UE capability information indicates whether the UE supports one or more of the following:

a master cell group (MCG) split bearer not comprising Packet Data Convergence Protocol (PDCP) uplink data transmission;

a secondary cell group (SCG) bearer;

an SCG split bearer not comprising uplink PDCP data transmission;

an MCG split bearer of PDCP uplink data transmission; and.

an SCG split bearer of PDCP uplink data transmission,

where a radio protocol layer of the MCG split bearer is located in a master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station, an LTE base station, or an eLTE base station; the secondary base station may be an NR base station, an LTE base station, or an eLTE base station; and the core network may be an evolved packet core (EPC) or a next-generation core network.

In one embodiment, the UE capability information indicates whether the UE supports one or more of the following:

an MCG split bearer not comprising PDCP uplink data transmission and using an NR base station as a master base station;

an SCG bearer using an NR base station as the master base station;

an SCG split bearer not comprising PDCP uplink data transmission and using an NR base station as the master base station;

an MCG split bearer of PDCP uplink data transmission using an NR base station as the master base station; and

an SCG split bearer of PDCP uplink data transmission using an NR base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an NR base station as a master base station and an LTE base station as a secondary base station;

an MCG split bearer not comprising PDCP uplink data transmission and using an NR base station as the master base station and an eLTE base station as the secondary base station;

an MCG split bearer not comprising PDCP uplink data transmission and using an NR base station as the master base station and an NR base station as the secondary base station;

an SCG bearer using an NR base station as the master base station and an LTE base station as the secondary base station;

an SCG bearer using an NR base station s the master base station and an eLTE base station as the secondary base station;

an SCG bearer using an NR base station as the master base station and an NR base station as the secondary base station;

an SCG split bearer not comprising PDCP uplink data transmission and using an NR base station as the master base station and an LTE base station as the secondary base station;

an SCG split bearer not comprising PDCP uplink data transmission and using an NR base station as the master base station and an eLTE base station as the secondary base station;

an SCG split bearer not comprising PDCP uplink data transmission and using an NR base station as the master base station and an NR base station as the secondary base station;

an MCG split bearer of PDCP uplink data transmission using an NR base station as the master base station and an LTE base station as the secondary base station;

an MCG split bearer of PDCP uplink data transmission using an NR base station as the master base station and an eLTE base station as the secondary base station;

an MCG split bearer of PDCP uplink data transmission using an NR base station as the master base station and an NR base station as the secondary base station;

an SCG split bearer of PDCP uplink data transmission using an NR base station as the master base station and an LTE base station as the secondary base station;

an SCG split bearer of PDCP uplink data transmission using an NR base station as the master base station and an eLTE base station as the secondary base station; and

an SCG split bearer of PDCP uplink data transmission using an NR base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an NR base station; the secondary base station may be an NR base station, an LTE base station, or an eLTE base station; and the core network is a next-generation core network.

In one embodiment, the UE capability information indicates whether the UE supports one or more of the following:

an MCG split bearer not comprising PDCP uplink data transmission and using an LTE base station as a master base station;

an SCG bearer using an LTE base station as the master base station;

an SCG split bearer not comprising PDCP uplink data transmission and using an LTE base station as the master base station;

an MCG split bearer of PDCP uplink data transmission using an LTE base station as the master base station; and

an SCG split bearer of PDCP uplink data transmission using an LTE base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the JE supports one or more of the following:

an MCG split bearer not comprising PDCP uplink data transmission and using an LTE base station as a master base station and an LTE base station as a secondary base station;

an MCG split bearer not comprising PDCP uplink data transmission and using an LTE base station as the master base station and an eLTE base station as the secondary base station;

an MCG split bearer not comprising PDCP uplink data transmission and using an LTE base station as the master base station and an NR base station as the secondary base station;

an SCG bearer using an LTE base station as the master base station and an LTE base station as the secondary base station;

an SCG bearer using an LTE base station as the master base station and an eLTE base station as the secondary base station;

an SCG bearer using an LTE base station as the master base station and an NR base station as the secondary base station;

an SCG split bearer not comprising PDCP uplink data transmission and using an LTE base station as the master base station and an LTE base station as the secondary base station;

an SCG split bearer not comprising PDCP uplink data transmission and using an LTE base station as the master base station and an eLTE base station as the secondary base station;

an SCG split bearer not comprising PDCP uplink data transmission and using an LTE base station as the master base station and an NR base station as the secondary base station;

an MCG split bearer of PDCP uplink data transmission using an LTE base station as the master base station and an LTE base station as the secondary base station;

an MCG split bearer of PDCP uplink data transmission using an LTE base station as the master base station and an eLTE base station as the secondary base station;

an MCG split bearer of PDCP uplink data transmission using an LTE base station as the master base station and an NR base station as the secondary base station;

an SCG split bearer of PDCP uplink data transmission using an LTE base station as the master base station and an LTE base station as the secondary base station;

an SCG split bearer of PDCP uplink data transmission using an LTE base station as the master base station and an eLTE base station as the secondary base station; and

an SCG split bearer of PDCP uplink data transmission using an LTE base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an LTE base station; the secondary base station may be an NR base station, an LTE base station, or an eLTE base station; and the core network is an EPC.

In one embodiment, the UE capability information indicates whether the UE supports one or more of the following:

an MCG split bearer not comprising PDCP uplink data transmission and using an eLTE base station as a master base station;

an SCG bearer using an eLTE base station as the master base station;

an SCG split bearer not comprising PDCP uplink data transmission and using an eLTE base station as the master base station;

an MCG split bearer of PDCP uplink data transmission using an eLTE base station as the master base station; and

an SCG split bearer of PDCP uplink data transmission using an eLTE base station as the master base station,

where a radio protocol layer of the MCG split bearer is located in the master base station and a secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the UE capability information indicates whether the UE supports one or more of the following:

an MCG split bearer not comprising PDCP uplink data transmission and using an eLTE; base station as a master base station and an LTE base station as a secondary base station;

an MCG split bearer not comprising PDCP uplink data transmission and using an eLTE base station as the master base station and an eLTE base station as the secondary base station;

an MCG split bearer not comprising PDCP uplink data transmission and using an eLTE base station as the master base station and an NR base station as the secondary base station;

an SCG bearer using an eLTE base station as the master base station and an LTE base station as the secondary base station;

an SCG bearer using an eLTE base station as the master base station and an eLTE base station as the secondary base station;

an SCG bearer using an eLTE base station as the master base station and an NR base station as the secondary base station;

an SCG split bearer not comprising PDCP uplink data transmission and using an eLTE base station as the master base station and an LTE base station as the secondary base station;

an SCG split bearer not comprising PDCP uplink data transmission and using an eLTE base station as the master base station and an eLTE base station as the secondary base station;

an SCG split bearer not comprising PDCP uplink data transmission and using an eLTE base station as the master base station and an NR base station as the secondary base station;

an MCG split bearer of PDCP uplink data transmission using an eLTE base station as the master base station and an LTE base station as the secondary base station;

an MCG split bearer of PDCP uplink data transmission using an eLTE base station as the master base station and an eLTE base station as the secondary base station;

an MCG split bearer of PDCP uplink data transmission using an eLTE base station as the master base station and an NR base station as the secondary base station;

an SCG split bearer of PDCP uplink data transmission using an eLTE base station as the master base station and an LTE base station as the secondary base station;

an SCG split bearer of PDCP uplink data transmission using an eLTE base station as the master base station and an eLTE base station as the secondary base station; and

an SCG split bearer of PDCP uplink data transmission using an eLTE base station as the master base station and an NR base station as the secondary base station,

where a radio protocol layer of the MCG split bearer is located in the master base station and the secondary base station; user plane data with a core network ends at the master base station, and resources of both the master base station and the secondary base station are used;

a radio protocol layer of the SCG split bearer is located in the master base station and the secondary base station; user plane data with the core network ends at the secondary base station, and resources of both the master base station and the secondary base station are used; and

a radio protocol layer of the SCG bearer is located in the secondary base station, and resources of the secondary base station are used.

In one embodiment, the master base station is an eLTE base station; the secondary base station may be an NR base station, an LTE base station, or an eLTE base station; and the core network is a next-generation core network.

In the receiving unit 810, the UE can simultaneously indicate one or more capabilities in the embodiments listed above. In the sending unit 820, the eNB can configure for the UE one or more bearers corresponding to one or more capabilities in the embodiments listed above.

The embodiments and exemplary situations described above with respect to the method 500 are also applicable to the UE 600, the method 700, and the base station 800.

In addition, the present invention is described by using data bearers as an example. It should be understood that the present invention is also applicable to signaling bearers (SRBs); and the corresponding user data plane should be a control plane.

If the UE reports a DRB type that it supports to only one type of radio access technology (RAT): NR, LTE, or eLTE, then an EPC or a next-generation core network may notify, through EPC or an interface between the next-generation core network and a base station, the base station of DRB types relevant to other types of base stations and supported by the UE. For example, the UE reports, to an eLTE base station (or a next-generation core network), DRB types supported by the UE (including DRB types supported when the eLTE base station serves as the MeNB and DRB types supported when a gNB or an LTE eNB serves as the MeNB). In this case, the next-generation core network notifies the eLTE base station of other types of DRBs supported by the LTE (for example, DRB types supported by the UE when a gNB or an LTE eNB serves as the MeNB).

The program running on the device according to the present invention may be a program that enables the computer to implement the functions of the embodiments of the present invention by controlling the central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions can be achieved by the computer system through reading programs recorded on the recording medium and executing them. The so-called “computer system” herein may be a computer system embedded in the device, which may include operating systems or hardware (for example, peripherals). The “computer-readable recording medium” may be a semiconductor recording medium, an optical recording medium, a magnetic recording medium, a recording medium for programs that are dynamically stored for a short time, or any other computer-readable recording medium.

Various features or functional modules of the device used in the above embodiments may be implemented or executed through circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, a controller, a microcontroller, or a state machine. The circuit may be a digital circuit or an analog circuit. When new integrated circuit technologies that replace existing integrated circuits emerge because of the advances in semiconductor technology, one or more embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims, Embodiments resulted from the appropriate combinations of the technical means disclosed in different embodiments are also included within the technical scope of the present invention, In addition, components with the same effect described in the above embodiments may be replaced with one another.

1. A method executed by user equipment (UE), comprising:
sending to a master base station UE capability information related to bearer types supported by the UE, wherein the bearer types comprise New Radio (NR), Long Term Evolution (LTE), and/or enhanced Long Term Evolution eLTE); and
receiving, from the master base station, configurations of the bearer types.

2. The method according to claim 1, wherein the UE capability information indicates whether the UE supports one or more of the following:
a master cell group (MCG) split bearer not comprising Packet Data Convergence Protocol (PDCP) uplink data transmission;
a secondary cell group (SCG) bearer;
an SCG split bearer not comprising uplink PDCP data transmission;
an MCG split bearer of PDCP uplink data transmission; and
an SCG split bearer of PDCP uplink data transmission, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

3. (canceled)

4. The method according to claim 1, wherein the UE capability information indicates whether the UE supports one or more of the following:
an MCG split bearer not comprising PDCP uplink data transmission and using an NR base station as the master base station;
an SCG bearer using an NR base station as the master base station;
an SCG split bearer not comprising PDCP uplink data transmission and using an NR base station as the master base station;
an MCG split bearer of PDCP uplink data transmission and using an NR base station as the master base station; and
an SCG split bearer of PDCP uplink data transmission and using an NR base station as the roaster base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

5. The method according to claim 1, wherein the UE capability information indicates whether the UE supports one or more of the following:
an MCG split bearer not comprising PDCP uplink data transmission and using an NR base station as the master base station and an LTE base station as the secondary base station;
an MCG split bearer not comprising PDCP uplink data transmission and using an NR base station as the master base station and an eLTE base station as the secondary base station;
an MCG split bearer not comprising PDCP uplink data transmission and using an NR base station as the master base station and an NR base station as the secondary base station;
an SCG bearer using an NR base station as the master base station and an LTE base station as the secondary base station;
an SCG bearer using an NR base station as the master base station and an eLTE base station as the secondary base station;
an SCG bearer using an NR base station as the master base station and an NR base station as the secondary base station;
an SCG split bearer not comprising PDCP uplink data transmission and using an NR base station as the master base station and an LTE base station as the secondary base station;
an SCG split bearer not comprising PDCP uplink data transmission and using an NR base station as the master base station and an eLTE base station as the secondary base station;
an SCG split bearer not comprising PDCP uplink data transmission and using an NR base station as the master base station and an NR base station as the secondary base station;
an MCG split bearer of PDCP uplink data transmission using an NR base station as the master base station and an LTE base station as the secondary base station;
an MCG split bearer of PDCP uplink data transmission using an NR base station as the master base station and an eLTE base station as the secondary base station;
an MCG split bearer of PDCP uplink data transmission using an NR base station as the master base station and an NR base station as the secondary base station;
an SCG split bearer of PDCP uplink data transmission using an NR base station as the master base station and an LTE base station as the secondary base station;
an SCG split bearer of PDCP uplink data transmission using an NR base station as the master base station and an eLTE base station as the secondary base station; and
an SCG split bearer of PDCP uplink data transmission using an NR base station as the master base station and an NR base station as the secondary base station, wherein
a radio protocol layer of the MCG split bearer is located in the master base station and the secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

6. (canceled)

7. The method according to claim 1, wherein the UE capability information indicates whether the UE supports one or more of the following:
an MCG split bearer not comprising PDCP uplink data transmission and using an LTE base station as the master base station;
an SCG bearer using an LTE base station as the master base station;
an SCG split bearer not comprising PDCP uplink data transmission and using an LTE base station as the master base station;
an MCG split bearer of PDCP uplink data transmission and using an LTE base station as the master base station; and
an SCG split bearer of PDCP uplink data transmission and using an LTE base station as the master base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

8-12. (canceled)

13. User equipment (UE), comprising:
a sending unit, configured to send to a master base station UE capability information related to bearer types supported by the UE, wherein the bearer types comprise New Radio (NR), Long Term Evolution (LTE), and/or enhanced Long Term Evolution (eLTE); and
a receiving unit, configured to receive, from the master base station, configurations of the bearer types.

14. The UE according to claim 13, wherein the UE capability information indicates whether the UE supports one or more of the following:
a master cell group (MCG) split bearer not comprising Packet Data Convergence Protocol (PDCP) uplink data transmission;
a secondary cell group (SCG) bearer;
an SCG split bearer not comprising uplink PDCP data transmission;
an MCG split bearer of PDCP uplink data transmission; and
an SCG split bearer of PDCP uplink data transmission, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

15. (canceled)

16. The UE according to claim 13, wherein the LTE capability information indicates whether the UE supports one or more of the following:
an MCG split bearer not comprising PDCP uplink data transmission and using an NR base station as the master base station;
an SCG bearer using an NR base station as the master base station;
an SCG split bearer not comprising PDCP uplink data transmission and using an NR base station as the master base station;
an MCG split bearer of PDCP uplink data transmission and using an NR base station as the roaster base station; and
an SCG split bearer of PDCP uplink data transmission and using an NR base station as the master base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

17. The UE according to claim 13, wherein the UE capability information indicates whether the UE supports one or more of the following:
an MCG split bearer not comprising PDCP uplink data transmission and using an NR base station as the master base station and an LTE base station as the secondary base station;
an MCG split bearer not comprising PDCP uplink data transmission and using an NR base station as the master base station and an eLTE base station as the secondary base station;
an MCG split bearer not comprising PDCP uplink data transmission and using an NR base station as the master base station and an NR base station as the secondary base station;
an SCG bearer using an NR base station as the master base station and an LTE base station as the secondary base station;
an SCG bearer using an NR base station as the master base station and an eLTE base station as the secondary base station;
an SCG bearer using an NR base station as the master base station and an NR base station as the secondary base station;
an SCG split bearer not comprising PDCP uplink data transmission and using an NR base station as the master base station and an LTE base station as the secondary base station;
an SCG split bearer not comprising PDCP uplink data transmission and using an NR base station as the master base station and an eLTE base station as the secondary base station;
an SCG split bearer not comprising PDCP uplink data transmission and using an NR base station as the master base station and an NR base station as the secondary base station;
an MCG split bearer of PDCP uplink data transmission using an NR base station as the master base station and an LTE base station as the secondary base station;
an MCG split bearer of PDCP uplink data transmission using an NR base station as the master base station and an eLTE base station as the secondary base station;
an MCG split bearer of PDCP uplink data transmission using an NR base station as the master base station and an NR base station as the secondary base station;
an SCG split bearer of PDCP uplink data transmission using an NR base station as the master base station and an LTE base station as the secondary base station;
an SCG split bearer of PDCP uplink data transmission using an NR base station as the master base station and an eLTE base station as the secondary base station; and
an SCG split bearer of PDCP uplink data transmission using an NR base station as the master base station and an NR base station as the secondary base station, wherein
a radio protocol layer of the MCG split bearer is located in the master base station and the secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

18. (canceled)

19. The UE according to claim 13, wherein the UE capability information indicates whether the UE supports one or more of the following:
an MCG split bearer not comprising PDCP uplink data transmission and using an LTE base station as the master base station;
an SCG bearer using an LTE base station as the master base station;
an SCG split bearer not comprising PDCP uplink data transmission and using an LTE base station as the master base station;
an MCG split bearer of PDCP uplink data transmission and using an LTE base station as the master base station; and
an SCG split bearer of PDCP uplink data transmission and using an LTE base station as the master base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

20-24. (canceled)

25. A method executed by a base station, the base station being used as a master base station, the method comprising:
receiving, from UE, UE capability information related to bearer types supported by the UE, wherein the bearer types comprise New Radio (NR), Long Term Evolution (LTE), and/or enhanced Long Term Evolution eLTE); and
sending to the UE configurations of the bearer types according to the received UE capability information.

26. The method according to claim 25, wherein the UE capability information indicates whether the UE supports one or more of the following:
a master cell group (MCG) split bearer not comprising Packet Data Convergence Protocol (PDCP) uplink data transmission;
a secondary cell group (SCG) bearer;
an SCG split bearer not comprising uplink PDCP data transmission; an MCG split bearer of PDCP uplink data transmission; and
an SCG split bearer of PDCP uplink data transmission, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

27. (canceled)

28. The method according to claim 25, wherein the UE capability information indicates whether the UE supports one or more of the following:
an MCG split bearer not comprising PDCP uplink data transmission and using an NR base station as the master base station;
an SCG bearer using an NR base station as the master base station;
an SCG split bearer not comprising PDCP uplink data transmission and using an NR base station as the master base station;
an MCG split bearer of PDCP uplink data transmission and using an NR base station as the master base station; and
an SCG split bearer of PDCP uplink data transmission and using an NR base station as the master base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

29. The method according to claim 25, wherein the UE capability information indicates whether the UE supports one or more of the following:
an MCG split bearer not comprising PDCP uplink data transmission and using an NR base station as the master base station and an LTE base station as the secondary base station;
an MCG split bearer not comprising PDCP uplink data transmission and using an NR base station as the master base station and an eLTE base station as the secondary base station;
an MCG split bearer not comprising PDCP uplink data transmission and using an NR base station as the master base station and an NR base station as the secondary base station;
an SCG bearer using an NR base station as the master base station and an LTE base station as the secondary base station;
an SCG bearer using an NR base station as the master base station and an eLTE base station as the secondary base station;
an SCG bearer using an NR base station as the master base station and an NR base station as the secondary base station;
an SCG split bearer not comprising PDCP uplink data transmission and using an NR base station as the master base station and an LTE base station as the secondary base station;
an SCG split bearer not comprising PDCP uplink data transmission and using an NR base station as the master base station and an eLTE base station as the secondary base station;
an SCG split bearer not comprising PDCP uplink data transmission and using an NR base station as the master base station and an NR base station as the secondary base station;
an MCG split bearer of PDCP uplink data transmission using an NR base station as the master base station and an LTE base station as the secondary base station;
an MCG split bearer of PDCP uplink data transmission using an NR base station as the master base station and an eLTE base station as the secondary base station;
an MCG split bearer of PDCP uplink data transmission using an NR base station as the master base station and an NR base station as the secondary base station;
an SCG split bearer of PDCP uplink data transmission using an NR base station as the master base station and an LTE base station as the secondary base station;
an SCG split bearer of PDCP uplink data transmission using an NR base station as the master base station and an eLTE base station as the secondary base station; and
an SCG split bearer of PDCP uplink data transmission using an NR base station as the master base station and an NR base station as the secondary base station, wherein
a radio protocol layer of the MCG split bearer is located in the master base station and the secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

30. (canceled)

31. The method according to claim 25, wherein the UE capability information indicates whether the UE supports one or more of the following:
an MCG split bearer not comprising PDCP uplink data transmission and using an LTE base station as the master base station;
an SCG bearer using an LTE base station as the master base station;
an SCG split bearer not comprising PDCP uplink data transmission and using an LTE base station as the master base station;
an MCG split bearer of PDCP uplink data transmission and using an LTE base station as the master base station; and
an SCG split bearer of PDCP uplink data transmission and using an LTE base station as the master base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

32-36. (canceled)

37. A base station, being used as a master base station and the base station comprising:
a receiving unit, configured to receive, from UE, UE capability information related to bearer types supported by the UE, wherein the bearer types comprise New Radio (NR), Long Term Evolution (LTE), and/or enhanced Long Term Evolution (eLTE); and
a sending unit, configured to send to the UE, configurations of the bearer types according to the received UE capability information.

38. The base station according to claim 37, wherein the UE capability information indicates whether the UE supports one or more of the following:
a master cell group (MCG) split bearer not comprising Packet Data Convergence Protocol (PDCP) uplink data transmission;
a secondary cell group (SCG) bearer;
an SCG split bearer not comprising uplink PDCP data transmission; an MCG split bearer of PDCP uplink data transmission; and
an SCG split bearer of PDCP uplink data transmission, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

39. (canceled)

40. The base station according to claim 37, wherein the UE capability information indicates whether the UE supports one or more of the following:
an MCG split bearer not comprising PDCP uplink data transmission and using an NR base station as the master base station;
an SCG bearer using an NR base station as the master base station;
an SCG split bearer not comprising PDCP uplink data transmission and using an NR base station as the master base station;
an MCG split bearer of PDCP uplink data transmission and using an NR base station as the master base station; and
an SCG split bearer of PDCP uplink data transmission and using an NR base station as the master base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

41. The base station according to claim 37, wherein the UE capability information indicates whether the UE supports one or more of the following:
an MCG split bearer not comprising PDCP uplink data transmission and using an NR base station as the master base station and an LTE base station as the secondary base station;
an MCG split bearer not comprising PDCP uplink data transmission and using an NR base station as the master base station and an eLTE base station as the secondary base station;
an MCG split bearer not comprising PDCP uplink data transmission and using an NR base station as the master base station and an NR base station as the secondary base station;
an SCG bearer using an NR base station as the master base station and an LTE base station as the secondary base station;
an SCG bearer using an NR base station as the master base station and an eLTE, base station as the secondary base station;
an SCG bearer using an NR base station as the master base station and an NR base station as the secondary base station;
an SCG split bearer not comprising PDCP uplink data transmission and using an NR base station as the master base station and an LTE base station as the secondary base station;
an SCG split bearer not comprising PDCP uplink data transmission and using an NR base station as the master base station and an eLTE base station as the secondary base station;
an SCG split bearer not comprising PDCP uplink data transmission and using an NR base station as the master base station and an NR base station as the secondary base station;
an MCG split bearer of PDCP uplink data transmission using an NR base station as the master base station and an LTE base station as the secondary base station;
an MCG split bearer of PDCP uplink data transmission using an NR base station as the master base station and an eLTE base station as the secondary base station;
an MCG split bearer of PDCP uplink data transmission using an NR base station as the master base station and an NR base station as the secondary base station;
an SCG split bearer of PDCP uplink data transmission using an NR base station as the master base station and an LTE base station as the secondary base station;
an SCG split bearer of PDCP uplink data transmission using an NR base station as the master base station and an eLTE base station as the secondary base station; and
an SCG split bearer of PDCP uplink data transmission using an NR base station as the master base station and an NR base station as the secondary base station, wherein
a radio protocol layer of the MCG split bearer is located in the master base station and the secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

42. (canceled)

43. The base station according to claim 37, wherein the UE capability information indicates whether the UE supports one or more of the following:
an MCG split bearer not comprising PDCP uplink data transmission and using an LTE base station as the master base station;
an SCG bearer using an LTE base station as the master base station;
an SCG split bearer not comprising PDCP uplink data transmission and using an LTE base station as the master base station;
an MCG split bearer of PDCP uplink data transmission and using an LTE base station as the master base station; and
an SCG split bearer of PDCP uplink data transmission and using an LTE, base station as the master base station, wherein
a radio protocol layer of the MCG split bearer is located in the master base station and a secondary base station; user plane data with a core network ends at the master base station; and resources of both the master base station and the secondary base station are used;
a radio protocol layer of the SCG split bearer is located in the master base station and the secondary base station; user plane data with the core network ends at the secondary base station; and resources of both the master base station and the secondary base station are used; and
a radio protocol layer of the SCG bearer is located in the secondary base station, and resources of the secondary base station are used.

44-48. (canceled)
